(19) United States
(12) Patent Application Publication
(10) Pub. No.: US 2022/0234399 A1
(43) Pub. Date: Jul. 28, 2022

(54) TIRE PRESSURE REGULATION SYSTEM AND METHOD FOR USING SAME

(71) Applicant: John Henecke, Hiawatha, IA (US)

(72) Inventor: John Henecke, Hiawatha, IA (US)

(21) Appl. No.: 17/155,322

(22) Filed: Jan. 22, 2021

(51) Int. Cl. B60C 23/10; B60C 29/00; B60R 16/033

(52) U.S. Cl. CPC B60C 23/10; B60R 16/033; B60C 29/00

(57) ABSTRACT

An air pressure regulation system and method are provided. The system includes a pressure regulation system configured to be mounted within an axle of a moving vehicle having a tire mounted thereto. The pressure regulation system includes a pump assembly configured to continuously pump a gas into the tire. A release valve is configured to enable gas above a set pressure to pass from the tire through a second pneumatic fitting into the atmosphere. The release valve selectively closes after the air pressure within the tire no longer exceeds the predetermined level.

### BACKGROUND

The present disclosure generally relates to systems and methods for regulating the pressure within a tire and, in particular, to systems and methods for continuously pumping a gas, such as air, into a tire and venting the gas from the tire through a relief valve when the pressure exceeds a predetermined level.

The amount of pressure within the tire of a vehicle, such as a race car or other motorsports vehicle, affects the performance and handling of the vehicle. Air pressure affects the ability of the tire tread to grip the road or track. Pressure changes of as little as tenths of a pound per square inch (PSI) can cause the performance of tires to change. Maintaining each tire at the desired pressure level has been difficult. In racing, air pressure must be tightly controlled in order to achieve the best performance. A lower air pressure can provide better traction by increasing tread contact with the road, however, lower air pressure usually means the vehicle cannot achieve higher speeds. Conversely, a higher air pressure may produce higher speed given the reduced frictional forces, however, it usually means reduced traction and control. Air pressure that is too high can reduce traction to such a degree that the driver may lose control of the vehicle, or the tire may blow out and need to be replaced. In some types of racing cars, such as sprint cars, the rear tires may be larger than the front tires. Changes to air pressure within the large tires may occur to such an extent that gear ratios are affected.

The pressure within a tire changes in response to a corresponding change in temperature. As a tire heats up, the air pressure usually increases. The increased heat is generated by friction between the tire and the road or track. Tires typically heat up during a race when vehicles are driven at higher speeds for a relatively long time. Race drivers may try to anticipate air pressure changes that will occur as the tire heats up by initially underinflating their tires. A problem with underinflating the tires is that tire performance may be compromised until the tire heats up enough to reach the desired pressure.

After the tire temperature/pressure initially increases during the first few laps or miles of a race, it is possible the tire temperature/pressure could subsequently decrease during the race. For example, the tires may cool down during a pit stop or if the field of racing vehicles is driving slowly under a yellow flag.

Conventional bleeder valves, such as the one disclosed in U.S. Pat. No. 9,566,833 (Swindell) have been used to release air from a tire upon the air pressure reaching a predetermined level. Bleeder valves can use a spring-like regulator to let out air as the tire heats up. However, bleeder valves are not able to pump air into the tire to increase pressure when the air pressure is too low.

There is therefore a need for a device and method for regulating the pressure within a tire by reducing pressure when the pressure is too high and increasing pressure when the pressure is too low.

### SUMMARY

One aspect of the invention relates to a pressure regulation system configured to be mounted within an axle of a moving vehicle having a tire mounted thereto. The pressure regulation system includes a pump assembly configured to pump a gas, such as air, through a first pneumatic line and into the tire via a first pneumatic fitting. The pump assembly includes an air pump and a motor to provide mechanical power to the air pump. A release valve is configured to enable gas above a predetermined pressure level to pass from the tire through a second pneumatic fitting into the atmosphere. The release valve selectively opens to release the gas into the atmosphere and reduce the air pressure within the tire when the pressure within the tire exceeds the predetermined level. The release valve selectively closes after the air pressure within the tire no longer exceeds the predetermined level. The release valve may be a manual bleeder valve. More specifically, the release valve may be a manual pop off bleeder valve that contains a diaphragm seat. The diaphragm seat is preset with the pressure of a spring, which is adjusted by the height of the spring retainer, which puts more or less pressure on the seat to bleed off the air at a preset pressure. Alternatively, the release valve may be electrically actuated to open upon the receipt of a signal from a processor and close upon the receipt of another signal from the processor. Some embodiments include a power supply, such as a battery assembly having a battery, in communication with the motor to distribute electrical charges to the motor.

Another aspect of the invention relates to a pressure regulation system configured to be mounted within an axle of a moving vehicle having a tire mounted thereto. The pressure regulation system includes a pump assembly configured to pump a gas, such as air, through a first pneumatic line and into the tire via a first pneumatic fitting. The pump assembly includes an air pump and a motor to provide mechanical power to the air pump. A second pneumatic line is in fluid communication with the tire through a second pneumatic fitting, the second pneumatic line extending from a selectively adjustable pressure gage. The selectively adjustable pressure gage may be a digital pressure switch. A third pneumatic line is in fluid communication with the tire through a third pneumatic fitting, the third pneumatic line extending from an electronic solenoid valve. The pressure gage is in electrical communication with the electronic solenoid valve to allow the digital pressure gage to provide signals to the solenoid valve telling the solenoid valve to open or close. The pressure gage is configured to determine whether the pressure within the tire is above or below a predetermined level. The electronic solenoid valve is selectively operated by the selectively adjustable pressure gage to enable gas above a set pressure to pass to atmosphere. The electronic solenoid valve closes upon receiving a signal from the pressure gage when the pressure gage determines that the pressure within the tire is below the predetermined level. Some embodiments include a power supply, such as a battery assembly having a battery, the battery is in communication with the pump assembly, the selectively adjustable pressure gage, and the solenoid valve to distribute electrical charges to these components.

Another aspect of the invention relates to a method of regulating an air pressure within a tire mounted to an axel. The method includes mounting an electric pump assembly in an opening in the axel and activating the electric pump assembly to pump a gas, such as air, through a first pneumatic line and into the tire via a first pneumatic fitting. The pump assembly continuously pumps gas into the tire until the pump is turned off. In one exemplary embodiment, the pump continuously pumps gas into the tire during a race to help ensure the pressure within the tire remains at a predetermined level. To help prevent over inflation the method includes selectively opening a release valve in the tire to release the gas from the tire into the atmosphere and reduce the air pressure within the tire when the air pressure exceeds the predetermined level. The release valve selectively closes to prevent air from passing from the tire into the atmosphere after the air pressure no longer exceeds the predetermined level. In this manner the tire pressure remains at or around the predetermined level even as the tires warm and cool during a race. The release valve may be a manual bleeder. In some embodiments the release valve is a manual pop off bleeder valve that contains a diaphragm seat. The diaphragm seat is preset with the pressure of a spring, which is adjusted by the height of the spring retainer, which puts more or less pressure on the seat to bleed off the air at a preset pressure. Alternatively, the release valve may be electrically actuated to open upon the receipt of a signal and close upon the receipt of another signal.

Another aspect of the invention includes a method of regulating an air pressure within a tire mounted to an axel. The method includes mounting an electric pump assembly, an electronic solenoid valve, and a selectively adjustable pressure gage within an opening in the axel. Activating the electric pump assembly to pump a gas, such as air, through a first pneumatic line and into the tire via a first pneumatic fitting. The pump assembly continuously pumps gas into the tire until the pump is turned off. In one exemplary embodiment, the pump continuously pumps gas into the tire during a race to help ensure the pressure within the tire remains at a predetermined level. The selectively adjustable pressure gage determines when the air pressure within the tire is above or below a predetermined level. Upon determining that the air pressure exceeds a predetermined level, the pressure gage sends a signal to the electronic solenoid valve and the electronic solenoid valve is opened to release gas from the tire into the atmosphere and reduce the gas pressure within the tire. Upon determining the gas pressure is below the predetermined level, the pressure gage sends a signal to the electronic solenoid valve and the electronic solenoid valve closes to prevent gas from passing from the tire into the atmosphere. In this manner the tire pressure remains at or around the predetermined level even as the tires warm and cool during a race.

In some embodiments the pump assembly, electronic solenoid valve, selectively adjustable pressure gage, and battery assembly are all positioned within an opening in the axle and are configured to rotate with the axle and tire.

In some embodiments the axel has a proximal portion near a mouth of the opening and a distal portion axially spaced inward from the mouth of the opening, and wherein the pump is positioned at the distal portion behind the other components.

### BRIEF DESCRIPTION OF THE DRAWINGS

FIG. 1 is a side view of a vehicle wherein one tire has been enlarged to show one embodiment of the pressure regulation system mounted inside the axel.

FIG. 2 is a perspective view of an air pump.

FIG. 3 is a section view of the air pump taken along lines A-A in FIG. 2.

FIG. 4 is a section view taking along lines B-B in FIG. 1 wherein some features of the tire and rim have been removed to better illustrate the invention.

FIG. 5 is a side view of a vehicle wherein one tire has been enlarged to show a second embodiment the pressure regulation system mounted inside the axel.

FIG. 6 is a perspective view of the pressure regulation system.

FIG. 7 is a section view taken along lines C-C in FIG. 6.

FIG. 8 is a section view taking along lines D-D in FIG. 5 wherein some features of the tire and rim have been removed to better illustrate the invention.

### DETAILED DESCRIPTION

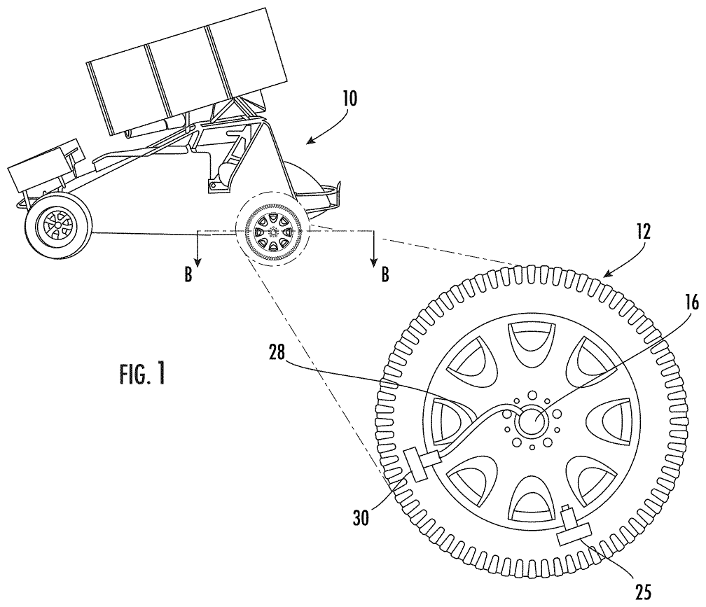

One aspect of the invention relates to a pressure regulation system configured to be mounted within an axle 36 of a moving vehicle having a tire 12 mounted thereto. The tire 12 may include other components, such as a rim. FIGS. 1-4 show a first embodiment of the pressure regulation system generally comprising a pump assembly 16 and a release valve 25. The pump assembly 16 is configured to be inserted into the axel 36. In some embodiments the pump assembly 16 housing includes an engagement member such as a lip adapted to engage a portion of the inner wall of the axel 36 to help secure the pump assembly 16 housing in the axel 36.

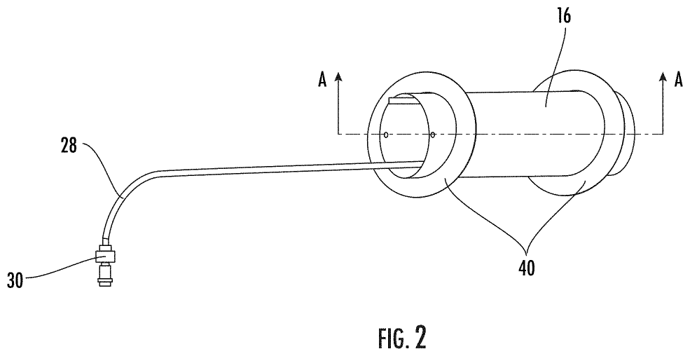

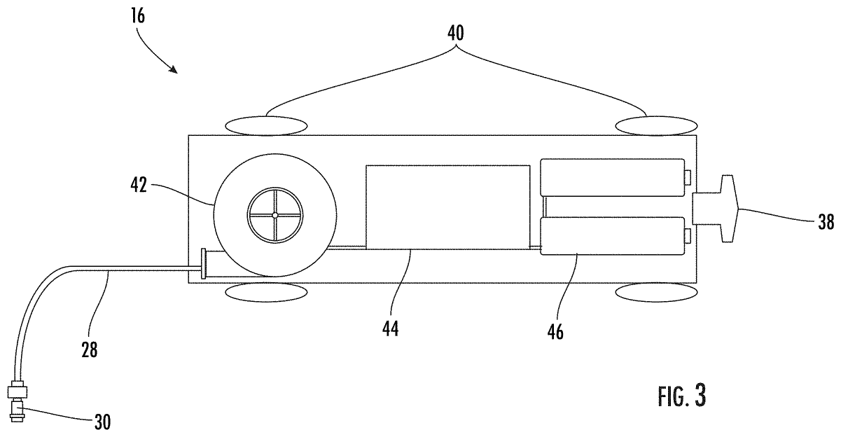

FIGS. 2 and 3 show the pump assembly 16. The pump assembly 16 generally includes an air pump 42 powered by a motor 44. In one embodiment the air pump 42 is electric and the motor 44 is a 12V DC motor powered by a battery assembly 46 having one or more batteries 46. The pump 42 is in communication with a first pneumatic line 28 so that air coming out of the pump 42 is directed into the first pneumatic line 28. In one embodiment the pump assembly 16 is configured to pump gas through the first pneumatic line 28 at a rate of between about four and five liters per minute. In one embodiment the pump assembly 16 is configured to pump gas through the first pneumatic line 28 at a rate of about four and a half liters per minute. The first pneumatic line 28 is adapted to be removably combined with a first pneumatic fitting 30 that is in fluid communication with the tire 12. The pump assembly 16 may be selectively turned on and off by actuating the actuating member 38, which may be a button or switch.

In one embodiment the pump assembly 16 includes one or more centering rings 40. The centering rings 40 are positioned around the pump assembly 16 as best shown in FIG. 2. In one embodiment the centering rings 40 are made from a plastic, rubber, or foam material having a compressed position and an expanded position. The centering rings 40 have a diameter that is generally smaller than the diameter of the opening in the vehicle's axel 36 when in its compressed position and larger than the diameter of the vehicle's axel 36 when in its expanded position. The centering rings 40 are biased in their expanded position. In use the centering rings 40 are compressed then placed inside the axel 36 where they move to their expanded position to secure the pump assembly 16 in the axel 36 by a friction fit. Upon inserting the pump assembly 16 in the axel 36, the centering rings 40 frictionally engage the inner surface of the axel 36 to help secure the pump assembly 16 in the axel 36 and to help hold the pump assembly 16 in the center of the axel 36. Centering the pump assembly 16 within the axel 36 helps maintain balance of the axel 36 and tire 12, especially at high speeds.

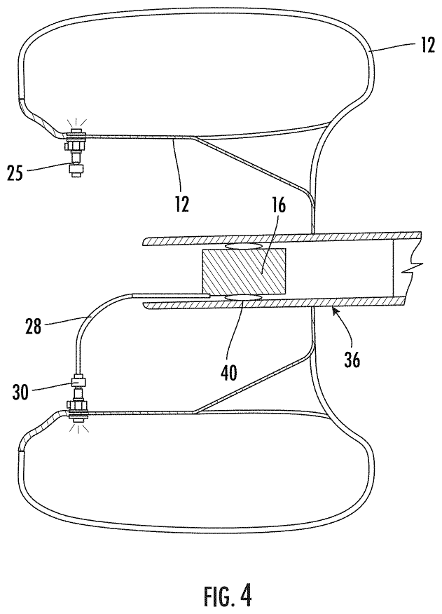

FIG. 4 shows the pressure regulation system mounted in the axel 36. The pump assembly 16 is configured to continuously pump a gas, such as air, through the first pneumatic line 28 and into the tire 12 via the first pneumatic fitting 30. The first pneumatic line 28 is removably connected to the first pneumatic fitting 30 so the pump assembly 16 can be removed from the axel 36 and detached from the tire 12. A release valve 25 is configured to enable the gas to pass from the interior tire 12 chamber to the atmosphere when the pressure within the tire 12 exceeds a predetermined level. The release valve 25 selectively opens to release a gas, such as air, into the atmosphere and reduce the air pressure within the tire 12 when the gas pressure exceeds the predetermined level. The release valve 25 closes after the gas pressure within the tire 12 no longer exceeds the predetermined level. The predetermined level may be a range such that the release valve 25 opens at a higher value (e.g. 12 psi) and closer at a lower value (e.g. 10 psi). Or, the release valve 25 may be configured to open and close at a predetermined level having a single value (e.g. 11 psi). The release valve 25 may be a manual pop off bleeder valve. In one embodiment the bleeder valve contains a diaphragm seat (not shown). The diaphragm seat is preset with the pressure of a spring, which is adjusted by the height of the spring retainer, which puts more or less pressure on the seats as to bleed off the air at a preset pressure. Alternatively, the release valve 25 may be electrically actuated to open upon the receipt of a signal from a processor and close upon the receipt of another signal from the processor.

In use, the pump assembly 16 is mounted within an opening in the axel 36 and the first pneumatic line 28 is connected to the first fitting 30. The electric pump assembly 16 is actuated to continuously pump gas through the first pneumatic line 28 and into the tire 12 via the first pneumatic fitting 30. The pump assembly 16 continuously pumps gas into the tire 12 until the pump is turned off. In one exemplary embodiment, the pump assembly 16 continuously pumps gas into the tire 12 during a race. The release valve 25 selectively opens to release the gas into the atmosphere and reduce pressure within the tire 12 when the pressure exceeds the predetermined level. The release valve 25 closes after the air pressure within the tire no longer exceeds the predetermined level. In this manner, the pump assembly 16 maintains the pressure within the tire 12 at or near the predetermined level. If the pressure within the tire 12 increases due to increased heat, then the release valve 25 simply releases the excess pressure until the pressure reaches the predetermined level. If the pressure within the tire 12 drops due to cooling, then the release valve 25 closes and the continuously running pump assembly 16 fills the tire 12 with gas until the predetermined level is reached and the release valve 25 opens again to release excess gas into the atmosphere. In order to help prevent over inflation, the release valve 25 is configured to release gas into the atmosphere at a rate which is greater than a rate of gas pumped into the tire 12 by the pump assembly 16.

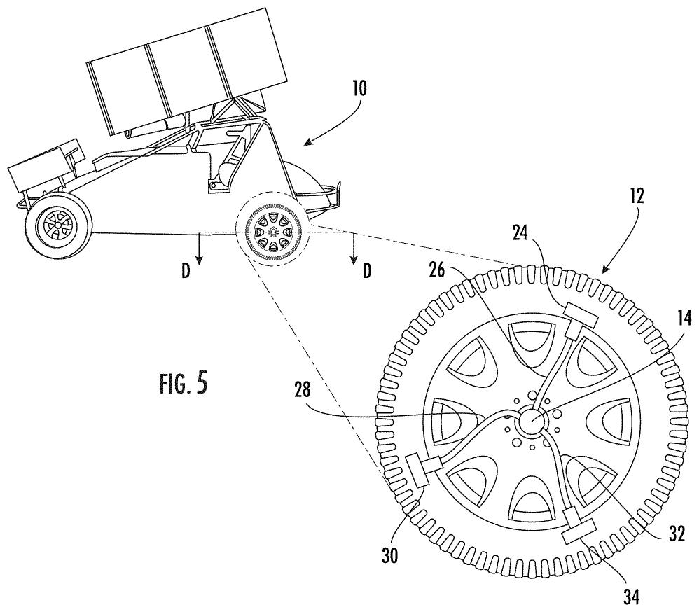

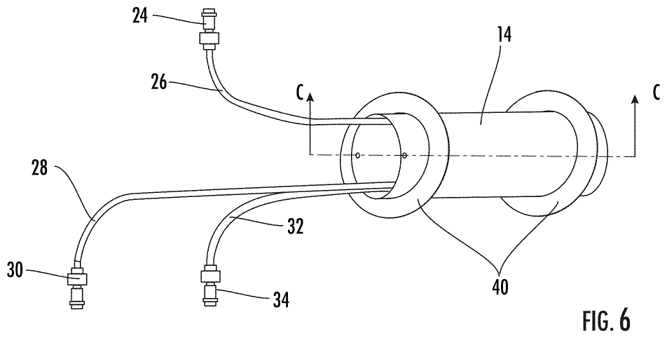

FIGS. 5-8 show a second embodiment of the pressure regulation system generally comprising a pump assembly 16, a selectively adjustable pressure gage 22, and an electronic solenoid valve 18. Some embodiments include a power supply 20 such as batteries to power the electrical components. FIGS. 6-8 show all of these components enclosed within a pressure regulation system housing 14, however, it is not necessary for all of the components to be enclosed within a single housing 14. For example, in some embodiments the selectively adjustable pressure gage 22, electronic solenoid valve 18, and power supply 20 are positioned in the housing 14 and the pump assembly 16 is a separate component as described above with respect to FIGS. 1-4. In some embodiments where the pump assembly 16 is not contained in the housing 14, the pump assembly 16 may be positioned in the axel 36 behind the housing 14. The axel 36 has a proximal portion near a mouth of the opening and a distal portion axially spaced inward from the mouth of the opening, and the selectively adjustable pressure gage 22, electronic solenoid valve 18, and power supply 20 (positioned in the housing 14) are positioned at the proximal portion of the axel 36 and the pump assembly 16 is positioned at the distal portion of the axel 36 behind the housing 14.

The housing 14 is configured to be inserted into the axel 36. In some embodiments the housing 14 includes an engagement member such as a lip adapted to engage a portion of the inner wall of the axel 36 to help secure the housing 14 in the axel 36.

One embodiment of the pump assembly 16 is described above and shown in FIG. 3 wherein the pump assembly 16 is configured to continuously pump a gas, such as air, through a first pneumatic line 28 and into the tire 12 via a first pneumatic fitting 30. The first pneumatic line 28 is removably connected to the first pneumatic fitting 30 so the pump assembly 16 can be removed from the axel 36 and detached from the tire 12.

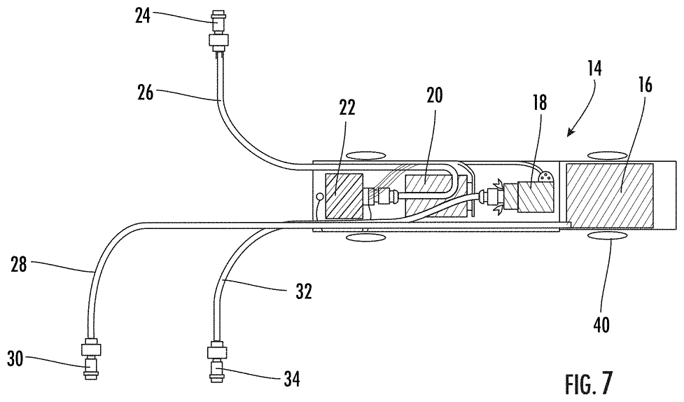

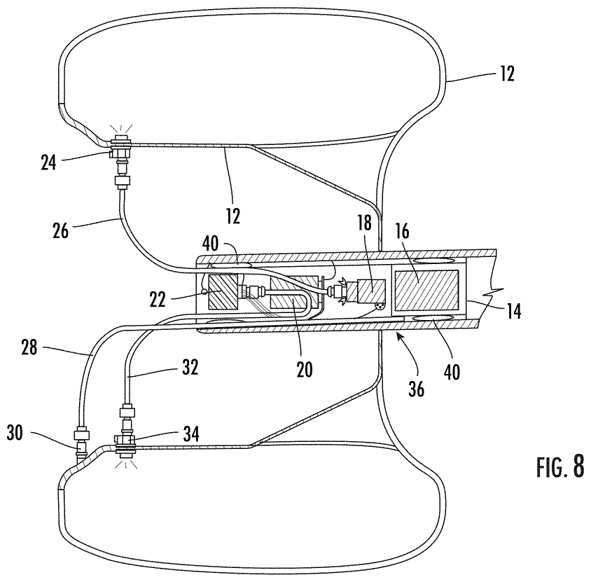

As shown in FIGS. 7 and 8, the selectively adjustable pressure gage 22 is in electrical communication with the electronic solenoid valve 18. The selectively adjustable pressure gage 22 continually measures the pressure within the tire 12 and sends signals to the solenoid valve 18 to open or close depending on whether the measured pressure within the tire 12 is above or below a predetermined level. A second pneumatic line 26 provides communication between the selectively adjustable pressure gage 22 and the tire 12 through a second pneumatic fitting 24. The second pneumatic line 26 is removably connected to the second pneumatic fitting 24 to allow the pressure regulation system to be removed from the tire 12.

The electronic solenoid valve 18 is in fluid communication with the interior of the tire 12 through a third pneumatic fitting 34 and is selectively operated by the selectively adjustable pressure gage 22 to enable gas above a set pressure to pass to atmosphere. A third line 32 provides communication between the electronic solenoid valve 18 and the selectively adjustable pressure gage 22 (or other processor). The third line 32 is removably connected to the third pneumatic fitting 34 to allow the pressure regulation system to be removed from the tire 12.

Some embodiments include a power supply 20, such as a battery assembly having a battery. The power supply 20 is in communication with the selectively adjustable pressure gage 22, the pump assembly 16, and the solenoid valve 18 to distribute electrical charges to these components. The power supply 20 shown in FIGS. 7 and 8 may also provide power to the pump assembly 16. In other words, it is not necessary to include a separate power supply 46 for the pump assembly 16. Instead, a single power supply (either 20 or 46) may be used to provide power to all of the electrical components in the pressure regulation system.

In some embodiments the pressure regulation system housing 14 includes one or more centering rings 40. The centering rings 40 are positioned around the housing 14 as best shown in FIG. 6. The centering rings 40 have a diameter that is generally smaller than the diameter of the opening in the vehicle's axel 36 when in its compressed position and larger than the diameter of the vehicle's axel 36 when in its expanded position. The centering rings 40 are biased in their expanded position. In use the centering rings 40 are compressed then placed inside the axel 36 where they move to their expanded position to secure the pump assembly 16 in the axel 36 by a friction fit. Upon inserting the housing 14 into the axel 36, the centering rings 40 frictionally engage the inner surface of the axel 36 to help secure the housing 14 in the axel 36 and to help hold the housing 14 in the center of the axel 36. Centering the housing 14 within the axel 36 is important to help maintain the balance of the axel 36 and tire 12, especially at high speeds.

In use, the electric pump assembly 16, electronic solenoid valve 18, and selectively adjustable pressure gage 22 are positioned within an opening in the axel 36 and each component is connected to its respective fitting using its respective pneumatic line. The electric pump assembly 16 is actuated to continuously pump gas through the first pneumatic line 28 and into the tire 12 via the first pneumatic fitting 30. The selectively adjustable pressure gage 22 determines when the air pressure within the tire 12 exceeds a predetermined level. The predetermined level may be a range such that the pressure gage 22 instructs the solenoid valve 18 to open at a higher value (e.g. 12 psi) and close at a lower value (e.g. 10 psi). Or, the pressure gage 22 may be programmed to open and close the solenoid valve 18 at a single predetermined value (e.g. 11 psi). If the pressure within the tire 12 is above the predetermined level, then the pressure gage 22 sends a signal to open the solenoid valve 18 to release gas into the atmosphere and reduce the air pressure within the tire 12. If the pressure within the tire 12 is below the predetermined level, then the pressure gage 22 sends a signal to close the solenoid valve 18 to allow the pump assembly 16 to build pressure within the tire 12 as the pump assembly 16 continuously runs. In order to help prevent over inflation, the solenoid valve 18 is configured to release gas into the atmosphere at a rate which is greater than a rate of gas pumped into the tire 12 by the pump assembly 16.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included within the scope of the following claims.

What is claimed is as follows:

1. A pressure regulation system configured to be mounted within an axel having an opening and to control a gas pressure within a tire mounted to the axel, comprising:
a pump assembly having a pump and an electric motor to power the pump, the pump assembly having an actuated state wherein the pump assembly is configured to pump gas via a first pneumatic line through a first fitting and into the tire;
a release valve in fluid communication with the tire, wherein the release valve is configured to move from a closed position to an open position to release gas from the tire when the gas pressure within the tire exceeds a predetermined level;
wherein in the actuated state the pump assembly is configured to continue pumping gas into the tire via the first pneumatic line through the first fitting and into the tire when the release valve is in its open position and when the release valve is in its closed position.

2. The pressure regulation system of claim 1 wherein the release valve is a manual pop off bleeder valve.

3. The pressure regulation system of claim 1 wherein the pump assembly is configured to pump gas into the tire at a first rate and the release valve is configured to release gas from the tire at a second rate, and the second rate is higher than the first rate.

4. The pressure regulation system of claim 1 further comprising a battery assembly having a battery, the battery in communication with the electric motor to distribute electrical charges to the electric motor.

5. The pressure regulation system of claim 1 further comprising one or more centering rings positioned around the pump assembly, wherein the centering rings have a diameter that is larger than a diameter of the opening in the axel.

6. A pressure regulation system configured to be mounted within an axel having an opening and to control a gas pressure within a tire mounted to the axel, comprising:
a pump assembly having a pump and an electric motor to power the pump, the pump assembly having an actuated state wherein the pump assembly is configured to pump gas through a first pneumatic line and into the tire via a first pneumatic fitting;
a selectively adjustable pressure gage in communication with the tire through a second pneumatic line and configured to determine whether the gas pressure within the tire is above or below a predetermined level, wherein the second pneumatic line is in communication with the tire through a second pneumatic fitting; and
an electronic solenoid valve, the electronic solenoid valve in electrical communication with the selectively adjustable pressure gage by electrical connection so that the electronic solenoid valve is in fluid communication with the interior of the tire, wherein the electronic solenoid valve is selectively operated between an open position and a closed position by the selectively adjustable pressure gage to enable gas above a set pressure to pass to atmosphere when in its open position;
wherein in the actuated state the pump assembly is configured to continue pumping gas into the tire via the first pneumatic line through the first fitting and into the tire when the electronic solenoid valve is in its open position and when the electronic solenoid valve is in its closed position.

7. The pressure regulation system of claim 6 wherein the pump assembly is configured to pump gas into the tire at a first rate and the release valve is configured to release gas from the tire at a second rate, and the second rate is higher than the first rate.

8. The pressure regulation system of claim 6 further comprising a battery assembly having a battery, the battery in communication with the electric motor, the selectively adjustable pressure gage, and the solenoid valve, wherein the battery assembly distributes electrical charges to activate the electric motor, the selectively adjustable pressure gage, and the electronic solenoid valve.

9. The pressure regulation system of claim 8 wherein the pump assembly, electronic solenoid valve, selectively adjustable pressure gage, and battery assembly are all positioned within the opening in the axle and are configured to rotate with the axle and tire.

10. The pressure regulation system of claim 9 wherein the axel has a proximal portion near a mouth of the opening and a distal portion axially spaced inward from the mouth of the opening, and wherein the selectively adjustable pressure gage and electronic solenoid valve are positioned within a housing positioned closer to the proximal portion and the pump assembly is positioned outside the housing and closer to the distal portion.

11. The pressure regulation system of claim 10 further comprising one or more centering rings positioned around the housing or the pump assembly, wherein the centering rings have a diameter that is larger than a diameter of the opening in the axel.

12. A method of regulating a gas pressure within a tire mounted to an axel, the method comprising:
mounting a pump assembly within an opening in the axel;
activating the pump assembly to continuously pump gas through a first pneumatic line and into the tire via a first pneumatic fitting;
positioning a release valve in fluid communication with the tire so that the release valve releases gas from the tire into the atmosphere and reduces the gas pressure within the tire when the gas pressure exceeds the predetermined level;
wherein the release valve closes after the air pressure within the tire no longer exceeds the predetermined level.

13. The method of claim 12 wherein the pump assembly includes a pump and an electric motor.

14. The method of claim 12 further comprising adjusting the release valve to change the predetermined level.

15. The method of claim 12 further comprising pumping gas into the tire at a first rate and the releasing gas from the tire at a second rate, and the second rate is higher than the first rate.

16. The pressure regulation system of claim 12 wherein the release valve is a manual pop off bleeder valve.

17. A method of regulating a gas pressure within a tire mounted to an axel, the method comprising:
mounting a pump assembly, an electronic solenoid valve, and a selectively adjustable pressure gage within an opening in the axel;
activating the pump assembly to continuously pump gas through a first pneumatic line and into the tire via a first pneumatic fitting;
determining when the gas pressure within the tire is above or below a predetermined level using the selectively adjustable pressure gage that is in fluid communication with the tire through a second pneumatic line and a second pneumatic fitting while continuing to pump gas through the first pneumatic line and into the tire via the first pneumatic fitting;
selectively opening the electronic solenoid valve to release gas into the atmosphere and reduce the gas pressure within the tire in response to a signal from the selectively adjustable pressure gage that the air pressure within the tire is above or below the predetermined level while continuing to pump gas through the first pneumatic line and into the tire via the first pneumatic fitting;
closing the electronic solenoid valve after the gas pressure within the tire no longer exceeds the predetermined level while continuing to pump gas through the first pneumatic line and into the tire via the first pneumatic fitting.

18. The method of claim 17 wherein the pump assembly includes a pump and an electric motor.

19. The method of claim 17 further comprising pumping gas into the tire at a first rate and the releasing gas from the tire at a second rate, wherein the second rate is higher than the first rate.

20. The method of claim 17 further comprising adjusting the selectively adjustable pressure gage to change the predetermined level.
